(19) United States
(12) Patent Application Publication
(10) Pub. No.: US 2025/0045865 A1
(43) Pub. Date: Feb. 6, 2025

(54) NON-LINEAR THUMBNAIL GENERATION SUPERVISED BY SALIENCY MAP

(71) Applicant: QUALCOMM Incorporated, San Diego, CA (US)

(72) Inventors: Simiao Wu, Shanghai (CN); Zhongbo Shi, Shanghai (CN); Weixing Wan, Baoshan District (CN); Qiwei Liu, Shanghai (CN)

(21) Appl. No.: 18/717,762

(22) PCT Filed: Feb. 4, 2022
(86) PCT No.: PCT/CN2022/075318

§ 371 Date: Jun. 7, 2024

(51) Int. Cl. G06T 3/40; G06V 10/46

(52) U.S. Cl. CPC G06T 3/40; G06V 10/462

(57) ABSTRACT

A computing device is configured to generate a thumbnail image. The computing device may receive a source image, downscale the source image to generate a downscaled image, process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image, and output the non-linear thumbnail image.

### TECHNICAL FIELD

The disclosure relates to image processing, including thumbnail image generation.

### BACKGROUND

A “thumbnail” or thumbnail image is a reduced size version of an image or picture of video. Thumbnails may be used as a preview of the content of a full size image or as a preview of the content of a video file. For example, thumbnail images may be used in websites, photo organization and organization applications, video organization and playback application, visual search engines, user interface icons, and the like. Because of their reduced size, many thumbnail images may be shown on the display of a computing device at the same time. As such, the content of many different images and/or videos may be quickly reviewed by a user.

### SUMMARY

In general, this disclosure describes techniques of generating thumbnail images. The techniques of this disclosure may be applied to any types of digital images or pictures, including still images, frames and/or pictures of a video file, a 2D projection of a 3D image or point cloud, a digital drawing, or any other visual digital file. The techniques of this disclosure include applying a non-linear transform to a source image to create a thumbnail image such that salient features of the source image are more prominent in the thumbnail image. As such, thumbnail images created using the techniques of this disclosure may be more useful as a preview of the content contained therein relative to other thumbnail generation techniques.

In some examples of the disclosure, a thumbnail image may be generated from a source image by first linearly downscaling the source image to an intermediate size. The intermediate size image is then processed by a neural network that generates the thumbnail image such that salient features of the source image are downscaled less than other features of the image. That is, the salient features in the thumbnail image are non-linearly scaled relative to the salient features in the source image. To achieve this non-linear transform, the neural network may be trained using saliency maps. The training of the neural network may include minimizing a loss function defined by a first loss relative to a saliency map ground truth and a second loss relative to a thumbnail image ground truth.

In one example, this disclosure describes an apparatus configured to generate a thumbnail image. The apparatus includes a memory configured to a source image, and one or more processors in communication with the memory. The one or more processors configured to receive the source image, downscale the source image to generate a downscaled image, process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image, and output the non-linear thumbnail image.

In another example, this disclosure describes a method for generating a thumbnail image, the method comprising receiving a source image, downscaling the source image to generate a downscaled image, processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image, and outputting the non-linear thumbnail image.

In another example, this disclosure describes a non-transitory computer-readable storage medium storing instructions that, when executed, cause one or more processors configured to generate a thumbnail image to receive a source image, downscale the source image to generate a downscaled image, process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image, and output the non-linear thumbnail image.

In another example, this disclosure describes an apparatus configured to generate a thumbnail image, the apparatus comprising means for receiving a source image, means for downscaling the source image to generate a downscaled image, means for processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image, and means for outputting the non-linear thumbnail image.

This disclosure also describes a method of training a neural network, the method comprising processing a source image with a neural network to generate a non-linear thumbnail image, the neural network operating according to parameters, generating a thumbnail saliency map from the non-linear thumbnail image, comparing the thumbnail saliency map to a saliency map ground truth to generate a first loss value, comparing the non-linear thumbnail image to a thumbnail image ground truth to generate a second loss value, and updating the parameters based on the first loss value and the second loss value.

This summary is intended to provide an overview of the subject matter described in this disclosure. It is not intended to provide an exclusive or exhaustive explanation of the systems, device, and methods described in detail within the accompanying drawings and description herein. Further details of one or more examples of the disclosed technology are set forth in the accompanying drawings and in the description below. Other features, objects, and advantages of the disclosed technology will be apparent from the description, drawings, and claims.

### BRIEF DESCRIPTION OF DRAWINGS

FIG. 1 is a block diagram of a device configured to generate non-linear thumbnail images according to the techniques of the disclosure.

FIG. 2 shows an example source image.

FIG. 3 shows examples of a linear thumbnail and a non-linear thumbnail generated according to the techniques of the disclosure.

FIG. 4 is a block diagram illustrating a device configured to generate a non-linear thumbnail using a saliency map supervised network according to the techniques of the disclosure.

FIG. 5 is a block diagram illustrating a process for training a saliency map supervised network according to the techniques of the disclosure.

FIG. 6 shows examples of a source image and a saliency map.

FIG. 7 is a process diagram illustrating a process for generating thumbnail and saliency ground truth images according to the techniques of the disclosure.

FIG. 8 illustrates a source image and a non-linear thumbnail generated according to the techniques of the disclosure.

FIG. 9 is a flowchart illustrating an example method for non-linear thumbnail generation according to the techniques of the disclosure.

### DETAILED DESCRIPTION

A “thumbnail” or thumbnail image is a reduced size version of an image or picture of video. Thumbnails may be used as a preview of the content of a full size image or as a preview of the content of a video file. For example, thumbnail images may be used in websites, photo organization and organization applications, video organization and playback application, visual search engines, user interface icons, and the like. Because of their reduced size, many thumbnail images may be shown on the display of a computing device at the same time. As such, the content of many different images and/or videos may be quickly reviewed by a user.

In some examples, thumbnail images are generated by linearly downscaling an image. Such a linear downscaling applies the same scaling ratios for all regions and/or objects in an image. For some image content, however, applying linear downscaling to a full size image to create a thumbnail may cause features of the original image to be hard to see. As such, the usefulness of the thumbnail as a preview of content may be reduced.

The techniques of this disclosure include applying non-linear processing to a source image to treat some important regions or interested objects (e.g., salient features) with different down-scaling ratios while maintaining a target thumbnail resolution. In some examples, the non-linear processing is achieved using a neural network that was trained using a saliency map. In this way, the trained neural network may be configured to identify important regions and/or interested objects and apply non-linear processing to such important regions and/or interested objects. This approach reduces visual loss during downscaling in visually sensitive regions (e.g., the salient features, important regions and/or interested objects), so as to achieve better thumbnail quality.

The techniques of this disclosure may also be more suitable for use on a mobile platform (e.g., tablet, mobile phone, etc.) as the techniques of this disclosure are less processing- and power-intensive than other thumbnail generation techniques. Other example techniques for thumbnail generation may include seam carving. In seam carving, a seam is a connected path of low energy pixels crossing the image from top to bottom, or from left to right. Seam carving uses an energy function defining the importance of pixels. The limitation of seam carving, especially for mobile platforms, is that seam carving is a high-complexity method that is unsuitable for hardware acceleration and is processing- and power-intensive.

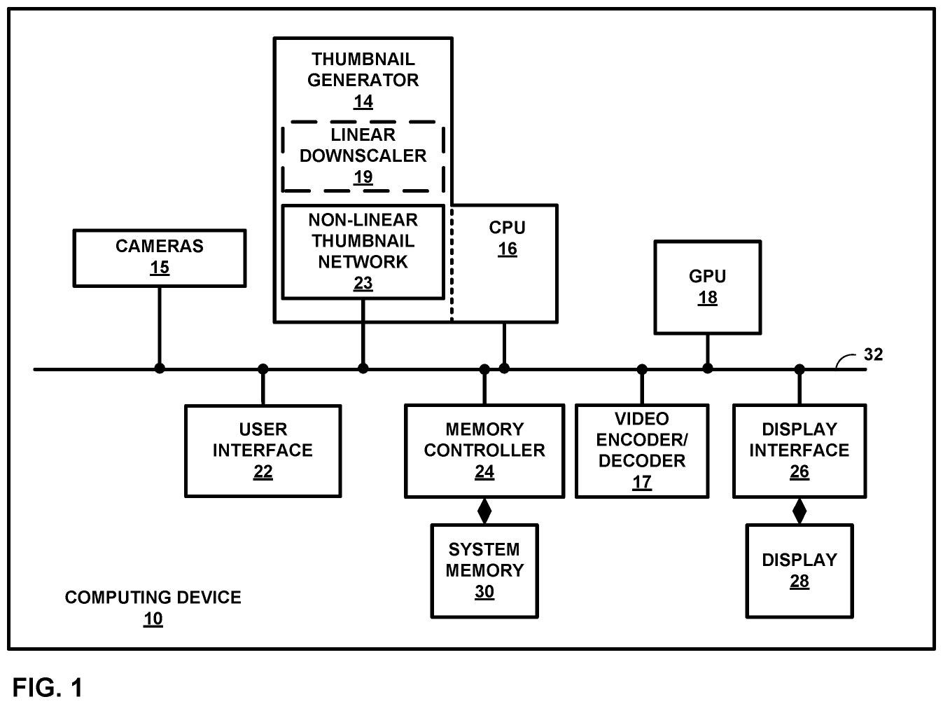

FIG. 1 is a block diagram of a computing device 10 configured to perform one or more of the example techniques described in this disclosure for generating non-linear thumbnail images. Examples of computing device 10 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), an Internet telephone, a digital camera, a digital video recorder, or another a handheld device, such as a portable video game device or a personal digital assistant (PDA). In some examples, computing device 10 may include one or more camera processor(s) 14, a central processing unit (CPU) 16, a video encoder/decoder 17, a graphics processing unit (GPU) 18, user interface 22, memory controller 24 that provides access to system memory 30, and display interface 26 that outputs signals that cause graphical data to be displayed on display 28.

As shown in FIG. 1, computing device 10 includes multiple cameras 15. As used herein, the term “camera” refers to a particular image sensor of computing device 10, or a plurality of image sensors of computing device 10, where the image sensors are arranged in combination with one or more lenses of computing device 10. Computing device 10 may receive one or more images from cameras 15. Images received from cameras 15 are one example of images that may be used by thumbnail generator 14 to generate a thumbnail image.

Computing device 10 may include a video encoder and/or video decoder 17, either of which may be integrated as part of a combined video encoder/decoder (CODEC) (e.g., a video coder). Video encoder/decoder 17 may include a video coder that encodes video captured by cameras 15 or a decoder that can decode compressed or encoded video data. Frames or pictures of video data captured by video encoder/decoder 17 are another example of images that may be used by thumbnail generator 14 to generate a thumbnail image.

GPU 18 may be any type of general-purpose or a special-purpose, highly-parallel processor that is configured to generate and/or manipulate images for display. Such images, may include frames of a graphical user interface (e.g., to be displayed on display 28), portions of graphical user interfaces, overlays for a graphical user interface, and/or frames of image data for gaming or other interactive use case. Frames or pictures of image data produced by GPU are examples of images that may be converted to thumbnail images by thumbnail generator 14.

CPU 16 may comprise a general-purpose or a special-purpose processor that controls operation of computing device 10. A user may provide input to computing device 10 to cause CPU 16 to execute one or more software applications. The software applications that execute on CPU 16 may include, for example, a camera application, a graphics editing application, a media player application, a video game application, a graphical user interface application or another program. The user may provide input to computing device 10 via one or more input devices (not shown) such as a keyboard, a mouse, a microphone, a touch pad or another input device that is coupled to computing device 10 via user interface 22.

One example software application is a photo organization application. CPU 16 executes the photo organization application, and in response, the photo organization application may cause CPU 16 to execute thumbnail generator 14 to generate thumbnail images for display on display 28. It should be understood that photo organization application (e.g., a photo gallery) is only one example of an application for which thumbnail generator 14 may be configured to generate thumbnail images. Other applications may include web browsers, video organization and playback applications, visual search engines, user interfaces, and the like.

Display 28 may include a monitor, a television, a projection device, an HDR display, a liquid crystal display (LCD), a plasma display panel, a light emitting diode (LED) array, an organic LED (OLED), electronic paper, a surface-conduction electron-emitted display (SED), a laser television display, a nanocrystal display or another type of display unit. Display 28 may be integrated within computing device 10. For instance, display 28 may be a screen of a mobile telephone handset, a tablet computer, or a laptop. Alternatively, display 28 may be a stand-alone device coupled to computing device 10 via a wired or wireless communications link. For instance, display 28 may be a computer monitor or flat panel display connected to a personal computer via a cable or wireless link.

The various structures illustrated in FIG. 1 may be configured to communicate with each other using bus 32. Bus 32 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different structures shown in FIG. 1 is merely exemplary, and other configurations of computing devices and/or other image processing systems with the same or different structures may be used to implement the techniques of this disclosure.

In some examples, memory controller 24 may facilitate the transfer of data going into and out of system memory 30. For example, memory controller 24 may receive memory read and write commands, and service such commands with respect to memory 30 in order to provide memory services for various components of computing device 10. In such examples, memory controller 24 may be communicatively coupled to system memory 30. Although memory controller 24 is illustrated in the example of computing device 10 of FIG. 1 as being a processing circuit that is separate from both CPU 16 and system memory 30, in some examples, some or all of the functionality of memory controller 24 may be implemented on one or more of CPU 16, system memory 30, video encoder/decoder 17, and/or GPU 18.

System memory 30 may store program modules and/or instructions and/or data that are accessible by thumbnail generator 14. CPU 16, and/or GPU 18. For example, system memory 30 may store user applications, images received from cameras 15, video files received from video encoder/decoder 17, images received from GPU 18, etc. System memory 30 may additionally store information for use by and/or generated by other components of computing device 10. For example, system memory 30 may act as a device memory for thumbnail generator 14. Thumbnail generator 14 may access images from system memory 30 to generate thumbnail images. System memory 30 may include one or more volatile or non-volatile memories or storage devices, such as, for example, RAM, SRAM, DRAM, ROM, EPROM, EEPROM, flash memory, a magnetic data media or an optical storage media.

In some examples, system memory 30 may include instructions that cause thumbnail generator 14 and/or CPU 16 to perform the functions ascribed to these components in this disclosure. Accordingly, system memory 30 may be a computer-readable storage medium having instructions stored thereon that, when executed, cause one or more processors (e.g., thumbnail generator 14. CPU 16, and/or another processor) to perform the various techniques of this disclosure.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

Thumbnail generator 14 may be configured to perform the techniques of this disclosure for generating a non-linear thumbnail image from a source image. In some examples, thumbnail generator 14 may be software that is executed by CPU 16. In other examples, thumbnail generator 14 may be firmware executed by a processor, e.g., one or more microprocessors, application specific integrated circuits (ASICs), field programmable gate arrays (FPGAs), digital signal processors (DSPs), or other equivalent integrated or discrete logic circuitry. In still other examples, the functionality of thumbnail generator 14 may be implemented directly in hardware.

Although the various structures of computing device 10 are illustrated as separate in FIG. 1, the techniques of this disclosure are not so limited, and in some examples the structures may be combined to form a system on chip (SoC). As an example, thumbnail generator 14, CPU 16, GPU 18, and display interface 26 may be formed on a common integrated circuit (IC) chip. In some examples, one or more of thumbnail generator, CPU 16, GPU 18, and display interface 26 may be formed on separate IC chips.

Various other permutations and combinations are possible, and the techniques of this disclosure should not be considered limited to the example illustrated in FIG. 1. In an example, CPU 16 may execute code that achieves the results of thumbnail generator 14, such that one or more components of thumbnail generator 14 are part of CPU 16. In such examples, CPU 16 may be configured to perform one or more of the various techniques otherwise ascribed herein to thumbnail generator 14. For purposes of this disclosure, thumbnail generator 14 will be described herein as being separate and distinct from CPU 16, although this may not always be the case.

As will be explained below, thumbnail generator 14 may be configured to receive a source image. Optionally, linear downscaler 19 of thumbnail generator 14 may be configured to downscale the source image to an intermediate size (e.g., a downscaled image). In some examples, this downscaled image is twice the resolution desired for the thumbnail image to be produced. However, other ratios between the intermediate size and the final thumbnail image may be used. In some examples, thumbnail generator 14 does not downscale the source image before processing with non-linear thumbnail network 23.

Non-linear thumbnail network 23 of thumbnail generator may process the downscaled image (or the source image without downscaling) with a non-linear transform to generate a non-linear thumbnail image. In one example, the non-linear transform is achieved with a neural network that is configured to operate according to parameters that were trained using saliency maps. The non-linear thumbnail image includes one or more non-linearly scaled salient features relative to one or more original salient features in the source image. Non-linear thumbnail network 23 may then output a thumbnail image to be used by one of the applications described above.

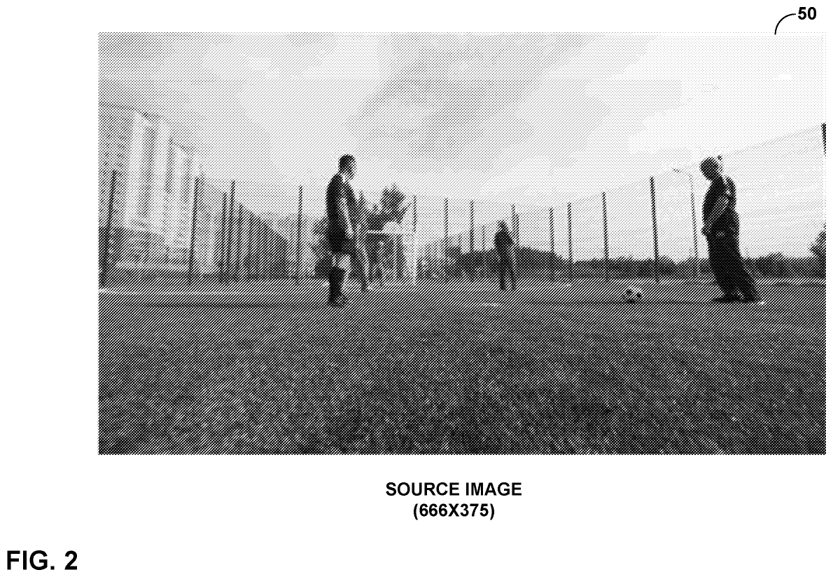

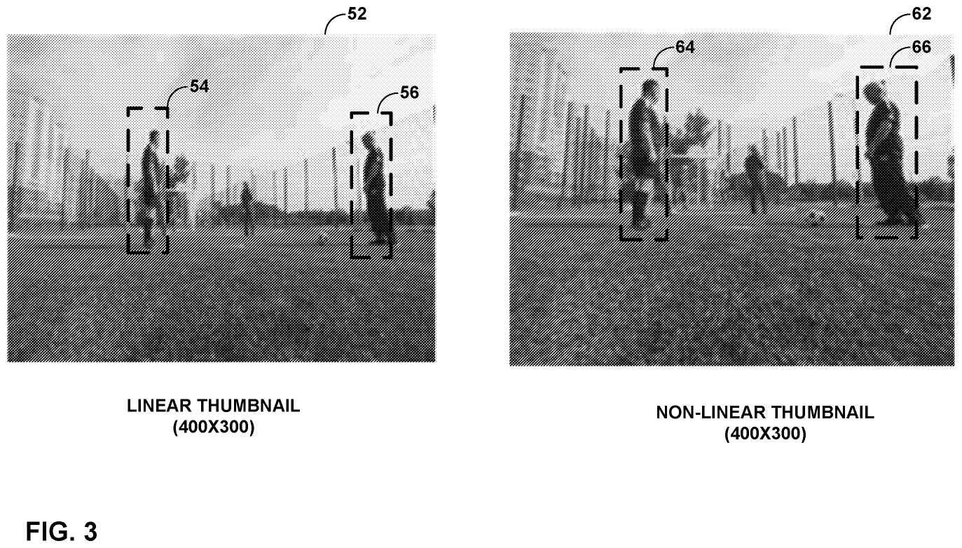

FIG. 2 shows an example source image 50. Source image 50 is a scene of a soccer match showing several players. In this example, source image 50 has 666×375 pixels. FIG. 3 shows examples of a linear thumbnail 52 and a non-linear thumbnail 62 generated according to the techniques of the disclosure. Linear thumbnail 52 is created with a simple linear downscaling of source image 50 from 666×375 pixels to 400×300 pixels. As shown in linear thumbnail 52, salient features 54 and 56 (e.g. the two soccer players) of the image are downscaled exactly in proportion to other features of the image. This may cause linear thumbnail 52 to be less useful in some thumbnail applications, as it may be difficult for a user to discern the identity of the players, or if the objects in the image are even players at all if the linear thumbnail is small enough.

Contrast linear thumbnail 52 with non-linear thumbnail 62 generated using the techniques of this disclosure. Non-linear thumbnail 62 is the same size (i.e., 400×300 pixels) as linear thumbnail 52. However, corresponding salient features 64 and 66 are much larger. In general, the techniques of this disclosure may apply less scaling to salient features, relative to other features in an image, while maintaining the same overall thumbnail size, thus the non-linear transformation. As such, the salient features in non-linear thumbnail 62 are much more visible to a user, and thus more useful in thumbnail applications.

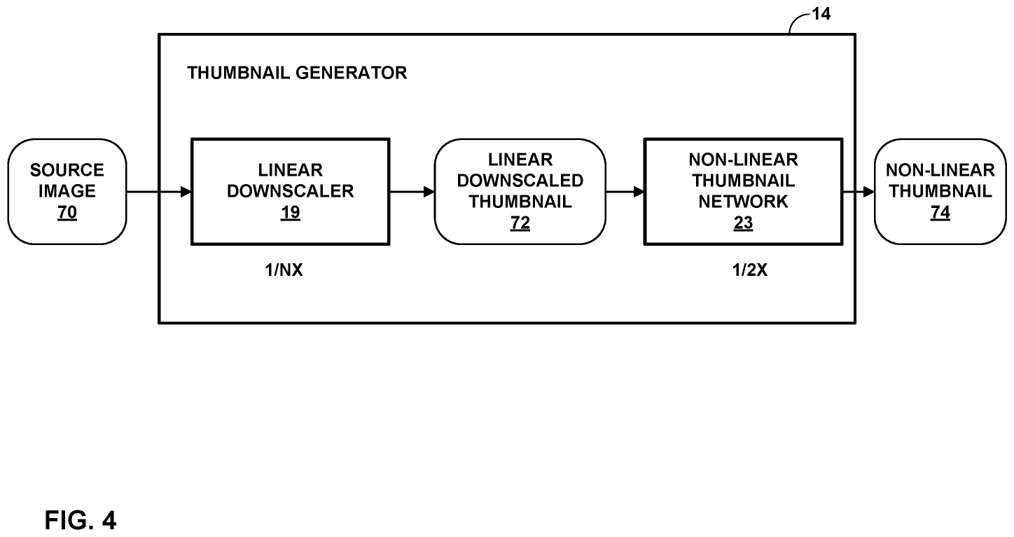

FIG. 4 is a block diagram illustrating a device configured to generate non-linear thumbnail using a saliency map supervised network according to the techniques of the disclosure. In FIG. 4, thumbnail generator 14 receives a source image 70. Linear downscaler 19 of thumbnail generator then downscales source image to an intermediate size, using a flexible 1/Nx scaling ratio, to produce linear downscaled thumbnail 72. In this example, the 1/Nx scaling ratio is twice the resolution (e.g., ½x) of the non-linear thumbnail 74 that is to be created by non-linear thumbnail network 23. However, other scaling ratios may be used. For example, the output resolution after linear downscaler 19 is 512×512 pixels, if target thumbnail resolution for non-linear thumbnail 74 is 256×256 pixels. By first downscaling source image to linear downscaled thumbnail 72, a standardized input size may be achieved for non-linear thumbnail network 23. That is, regardless of the size of source image 70, linear downscaler 19 will create a linear downscaled thumbnail 72 of a consistent size.

Non-linear thumbnail network 23 is configured to perform a non-linear process (e.g., a non-linear transform) on linear downscaled thumbnail 72 to produce non-linear thumbnail 74. In effect, non-linear thumbnail network 23 is configured to treat regions or objects of interest (e.g., a person, face, certain object, etc.) from source image 70 with different down-scaling ratios than the rest of the image, while maintaining a target thumbnail resolution. The regions or objects of interests are generally referred to as salient features. The resolution of non-linear thumbnail 74 is kept constant, but non-linear thumbnail 74 includes one or more non-linearly scaled salient features relative to one or more original salient features in the source image 70.

In one example of the disclosure, non-linear thumbnail network 23 may be configured as a non-linear neural network. The non-linear neural network may be one or more artificial neural networks (ANNs), including deep neural networks (DNNs) and/or convolutional neural networks (CNNs). In general, neural networks have shown great promise as classification tools. Non-linear thumbnail network 23 may include an input layer, an output layer, and one or more hidden layers between the input layer and the output layer. Non-linear thumbnail network 23 may also include one or more other types of layers, such as pooling layers.

Each layer may include a set of artificial neurons, which are frequently referred to simply as “neurons.” Each neuron in the input layer receives an input value from an input vector. Outputs of the neurons in the input layer are provided as inputs to a next layer in the network. Each neuron of a layer after the input layer may apply a propagation function to the output of one or more neurons of the previous layer to generate an input value to the neuron. The neuron may then apply an activation function to the input to compute an activation value. The neuron may then apply an output function to the activation value to generate an output value for the neuron. An output vector of the network includes the output values of the output layer of the network.

Each output layer neuron in the plurality of output layer neurons corresponds to a different output element in a plurality of output elements. Each output element in the plurality of output elements corresponds to a different classification. In the example of this disclosure, the classifications may be pixels being classified as salient pixels in the image and pixels not being salient pixels in the image. Non-linear thumbnail network 23 may then apply different scaling ratios to the salient pixels relative to other pixels in the image to generate non-linear thumbnail 74.

A computing system, such as computing device 10 may receive a plurality of training datasets that include annotated images as well as annotated saliency maps to train non-linear thumbnail network 23 to apply the non-linear transform to salient features of source image 70. The annotated images and saliency maps may include pixels that are manually identified as being salient features of the image.

For each respective training dataset, the training input vector of the respective training dataset comprises a value for each element of the plurality of input elements. For each respective training dataset, the target output vector of the respective training dataset comprises a value for each element of the plurality of output elements. In this example, the computing system may use the plurality of training datasets, including annotated saliency maps, to train non-linear thumbnail network 23.

As will be explained in more detail below, training non-linear thumbnail network 23 may include determining parameters of a neural network by minimizing a loss function. The parameters of the neural network may include weights applied to the output layers of and/or output functions for the layers of neural network. In one example, the loss function is defined by a first loss relative to a saliency map ground truth (e.g., a manually annotated saliency map) and a second loss relative to a thumbnail image ground truth (e.g., a manually annotated source image).

In one example, non-linear thumbnail network 23 is configured as a convolutional neural network. Convolutional neural networks convolve the input of a layer and pass the result to the next layer. A network structure has fully connected layers if the every neuron in one layer is connected to every neuron in another layer. A network with fully connected layers may also be called a multi-layer perceptron neural network (MLP).

In some examples, a pooling layer reduces the dimensions of data by combining the outputs of neurons at one layer into a single neuron in the next layer. Local pooling combines small data clusters. Global pooling involves all the neurons of the network. Two common types of pooling include max pooling and average pooling.

In some examples, each neuron in non-linear thumbnail network 23 computes an output value by applying a specific function to the input values received from the previous layer. The function that is applied to the input values is determined by a vector of weights and bias. The weights and bias for non-linear thumbnail network 23 may be included in parameters stored by computing device 10. As will be explained below, training non-linear thumbnail network 23 may include iteratively adjusting these biases and weights. The vector of weights and the bias are sometimes called filters and represent particular features of the input. In this example, the particular features of the input are pixels in the image that include salient features.

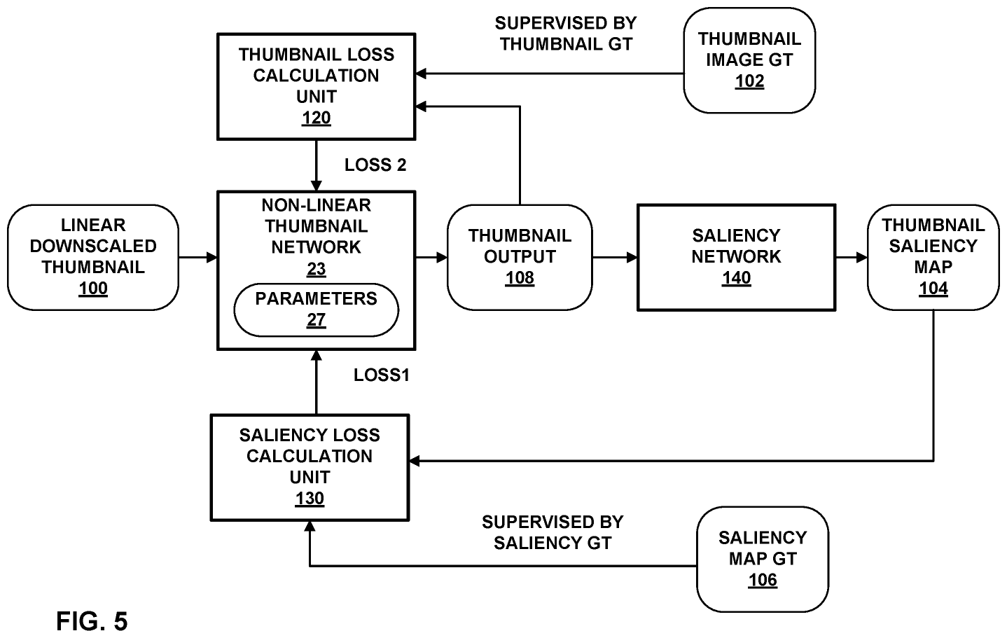

FIG. 5 is a block diagram illustrating a process for training a saliency map supervised network according to the techniques of the disclosure. FIG. 5 is described with respect to a single training image. However, it should be understood that non-linear thumbnail network 23 may be trained with a plurality of different images and saliency maps. The more images and saliency maps that are used to train non-linear thumbnail network 23, the more accurate the output will be.

Initially, non-linear thumbnail network 23 is configured to operate according to an initial sets of parameters 27 (e.g., the weights and biases) described above. Non-linear thumbnail network 23 takes a linear downscaled thumbnail 100 (e.g., a training image) as input and produces a thumbnail output 108. The thumbnail output 108 is a non-linear thumbnail produced using the non-linear transform of non-linear thumbnail network 23 based on an initial set of parameters 27.

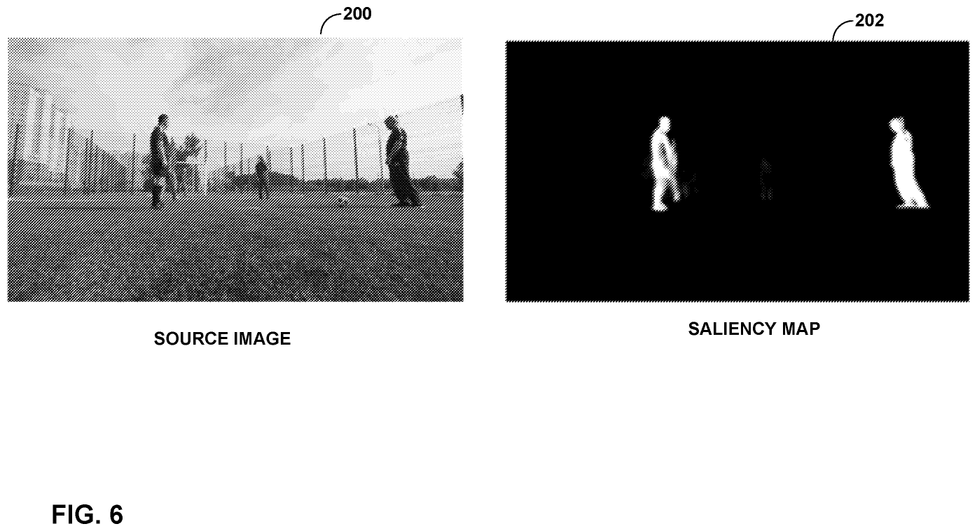

Thumbnail output 108 is then processed by saliency network 140 to produce a thumbnail saliency map 104. A saliency map is an image that highlights the pixels of particular regions or objects of interest in a source image. In general, a saliency map highlights regions and/or particular pixels of an image that are of more importance to the human visual system. Saliency network 140 may be a pre-defined network, such as a neural network, that is configured to produce a saliency map from an input image. FIG. 6 shows examples of a source image 200 and a corresponding saliency map 202. As can be seen in FIG. 6, pixels in saliency map 202 that are considered important regions or objects, or more generally, “salient features,” are assigned as white pixels. In this case, the soccer players are the salient features. All other pixels of saliency map 202 are assigned as black pixels.

Returning to FIG. 5, in some examples, saliency network 140 may be trained to output a saliency map that identifies generic salient features that may be most important to the human visual system. In other examples, saliency network 140 may be specifically trained to identify and/or give preference to specific types of salient features. Specific types of salient features may include faces, people, and/or one or more predefined objects.

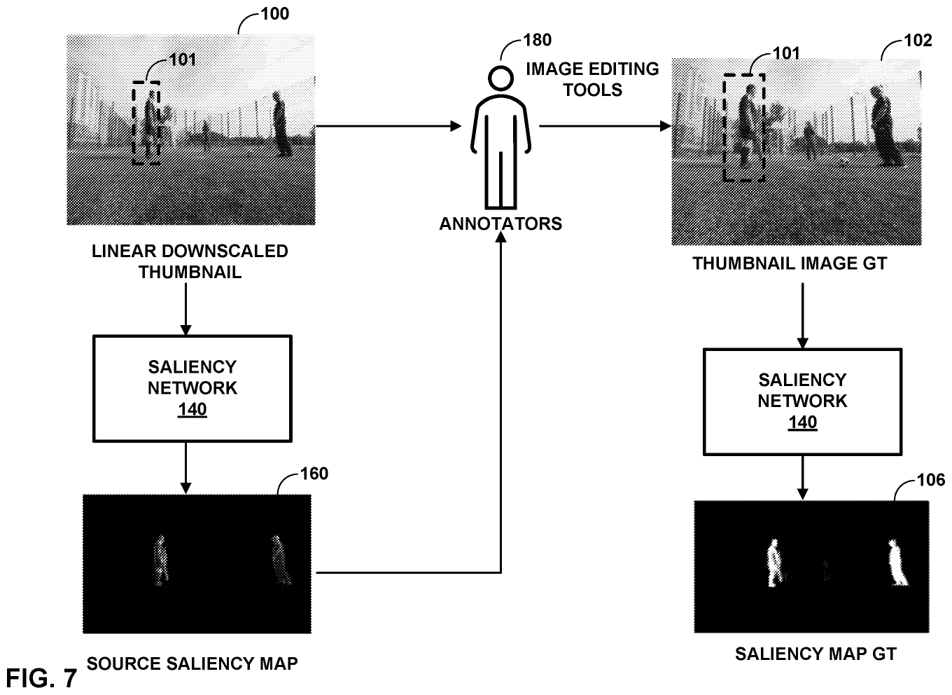

The computing device performing the neural network training may then determine two loss values based on thumbnail output 108 of non-linear thumbnail network 23 and the thumbnail saliency map 104 generated from thumbnail output 108. Thumbnail loss calculation unit 120 is configured to compare the pixels of thumbnail output 108 to thumbnail image ground truth (GT) 102. As will be explained in more detail below with reference to FIG. 7, thumbnail image GT 102 is a thumbnail image that is manually generated by a human annotator. In general, an annotator creates thumbnail image GT 102 by manually enlarging salient features in a test image (e.g., linear downscaled thumbnail 100). Only pixels around salient features are enlarged by the annotator. Thus, thumbnail image GT 102 represents an ideal output of non-linear thumbnail network 23 where salient features are enlarged, but other regions of the image are left at the original scale. In the context of this disclosure, the loss value calculated by thumbnail loss calculation unit 120 is referred to as a “second loss” or Loss₂.

Saliency loss calculation unit 130 may compare the pixels of thumbnail saliency map 104 to the pixels of saliency map ground truth (GT) 106. As will be explained in more detail below with reference to FIG. 7, saliency map GT 106 is generated by processing thumbnail image GT 102 with saliency network. Saliency map GT 106 represents the ideal sizing of salient features in the output of non-linear thumbnail network 23 without concern for the accuracy of non-salient features. This is because all pixels in a saliency map identified as not being salient are made black. In the context of this disclosure, the loss value calculated by saliency loss calculation unit 130 is referred to as a “first loss” or Loss₁.

The computing device (e.g., computing device 10 or another processor) training the non-linear thumbnail network 23 may update parameters 27 by minimizing a loss function defined by a first loss relative to a saliency map ground truth and a second loss relative to a thumbnail image ground truth. In general, parameters 27 of non-linear thumbnail network 23 may be considered to be supervised (e.g., trained) by both saliency map GT 106 and thumbnail image GT 102 using a tunable, weighted loss function. In one example, the loss function (Loss) is defined as Loss=α*Loss₁+(1−α)*Loss₂, wherein α is a weight, Loss₁ is the first loss, and Loss₂ is the second loss. The tunable weight value α is a weight that may range from 0 to 1.

A higher value of α (e.g., over 0.5) causes the loss function to be more biased toward minimizing saliency map loss. This may be beneficial for applications where it is desired to have more enlargement and accuracy of salient features, with less preservation of pixel values for non-salient regions. A lower value of a (e.g., under 0.5) causes the loss function to be more biased toward minimizing pixel loss between the source image and the non-linear thumbnail. This may be beneficial for applications where a less non-linear, higher fidelity thumbnail is desired with less exaggerated salient features.

By optimizing the loss function, and iteratively adjusting parameters 27, non-linear thumbnail network 23 may visually enlarge interested objects (e.g., salient features) while keeping the content consistent. In general, through the training process, thumbnail image GT 102 protects the overall appearance of the output thumbnail, while saliency map GT 106 ensures salient objects enlarged by non-linear thumbnail network 23 have an enlarged size as close to the size in saliency map GT 106 as possible.

In general, the output of the loss function described above is used to determine updated parameters (e.g., weights of each output layer of non-linear thumbnail network 23). These updated parameters replace the weights of parameters 27. The training process may be iteratively performed, and the parameters may be iteratively updated, over many instances of the training data set (e.g., called epochs) until a desired accuracy is achieved.

For some example feedforward neural networks, the process of updating the parameters is called backpropagation. When training non-linear thumbnail network 23, a training computing device may compute a gradient of a loss function with respect to the weights (e.g., parameters 27) of non-linear thumbnail network 23 for a single input-output example. The training computing device may perform a backpropagation algorithm that includes computing a gradient of the loss function with respect to each weight by a chain rule, computing the gradient one layer at a time, and iterating backward from the last layer to avoid redundant calculations of intermediate terms in the chain rule.

In summary, a computing device may be configured to train a neural network using one or more techniques of this disclosure. In one example, the computing device may process a source image with a neural network to generate a non-linear thumbnail image. The source image may be a linear downscaled thumbnail in some examples. The neural network may be configured to operate according to an initial set of parameters. The computing device may also generate a thumbnail saliency map from the non-linear thumbnail image. The computing device may be further configured to compare the thumbnail saliency map to a saliency map ground truth to generate a first loss value, and compare the non-linear thumbnail image to a thumbnail image ground truth to generate a second loss value. The computing device may then update the parameters based on the first loss value and the second loss value.

In general, updating the parameters based on the first loss value and the second loss value may include updating the parameters based on a loss function of the first loss value and the second loss value. In one example, the loss function (Loss) is defined by Loss=α*Loss₁+(1−α)*Loss₂, and wherein α is a weight, Loss₁ is the first loss value, and Loss₂ is the second loss value.

FIG. 7 is a process diagram illustrating a process for generating thumbnail and saliency ground truth images according to the techniques of the disclosure. A human annotator 180 may receive linear downscaled thumbnail 100, or more generally, a source image. Linear downscaled thumbnail 100 may be processed by saliency network 140 to produce source saliency map 160. Source saliency map 160 shows the salient features of linear downscaled thumbnail 100, such as salient feature 101. By viewing both the original source image, as well as a saliency map produced from that image, annotator 180 may more readily identify the salient features of the source image.

In general, annotator 180 refers to the source saliency map 160 to edit the linear downscaled thumbnail 100 by resizing the salient objects to have visually pleasurable size. In this way, the salient objects are enlarged in thumbnail image GT 102 after editing. Thumbnail image GT 102 is then processed by saliency network 140 to produce saliency map GT 106.

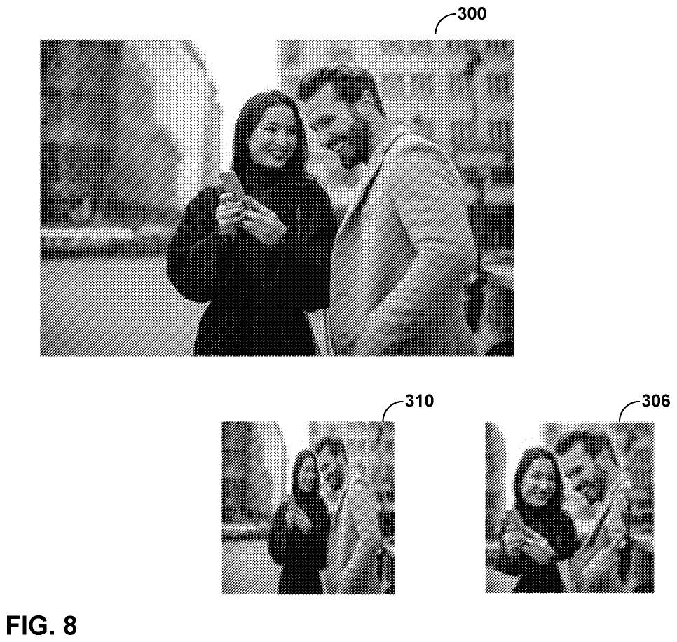

FIG. 8 illustrates another example of a source image 300 and a non-linear thumbnail 306 generated according to the techniques of the disclosure. FIG. 8 also shows an example of a linearly downscaled thumbnail 310. Non-linear thumbnail 306 has more prominent faces (e.g., salient features) relative to linearly downscaled thumbnail 310. As such, salient features of non-linear thumbnail 306 are more easily discernable by the human eye, making such a thumbnail more effective in conveying the content of source image 300.

In general, the techniques of this disclosure reduce visual loss during downscaling in visually sensitive regions (e.g., salient features), so as to achieve better thumbnail quality. In addition, compared with other content sensitive image resizing methods (e.g., seam carving for content-aware image resizing), the techniques of this disclosure avoid processing- and power-intensive energy seam calculations, which may be beneficial for mobile platforms and/or high resolution images.

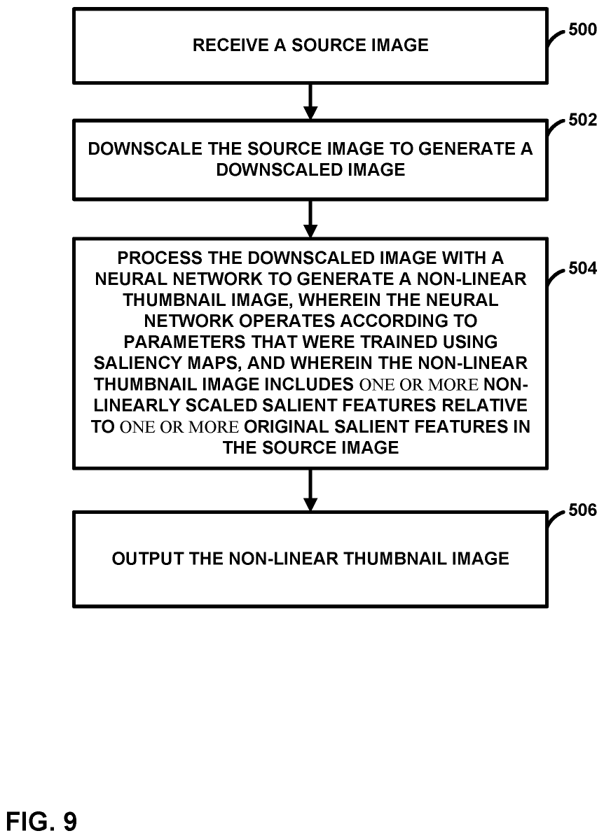

FIG. 9 is a flowchart illustrating an example method for non-linear thumbnail generation according to the techniques of the disclosure. The techniques of FIG. 9 may be performed by one or more structural components of computing device 10 of FIG. 1, including thumbnail generator 14.

In one example of the disclosure, computing device 10 may be configured to receive a source image (500), and downscale the source image to generate a downscaled image (502). In one example, computing device 10 may be configured to linearly downscale the source image to a resolution that is two times a final resolution of the non-linear thumbnail image.

Computing device 10 may be further configured to process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image (504). Computing device 10 may then output the non-linear thumbnail image (506). Computing device 10 may also be configured to display the non-linear thumbnail image along with other non-linear thumbnail images in a photo gallery application.

In some examples, the neural network operates according to parameters that were trained based on a loss function, wherein the loss function is defined by a first loss relative to a saliency map ground truth and a second loss relative to a thumbnail image ground truth. In one example, the loss function (Loss) is defined by Loss=α*Loss₁+(1−α)*Loss₂, wherein α is a weight, Loss₁ is the first loss, and Loss₂ is the second loss.

Additional illustrative aspects of the disclosure are listed below.

Aspect 1—An apparatus configured to generate a thumbnail image, the apparatus comprising: a memory configured to a source image; and one or more processors in communication with the memory, the one or more processors configured to: receive the source image; downscale the source image to generate a downscaled image; process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and output the non-linear thumbnail image.

Aspect 2—The apparatus of Aspect 1, wherein the neural network operates according to parameters that were trained based on a loss function, and wherein the loss function is defined by a first loss relative to a saliency map ground truth and a second loss relative to a thumbnail image ground truth.

Aspect 3—The apparatus of Aspect 2, wherein the loss function (Loss) is defined by Loss=α*Loss₁+(1−α)*Loss₂, and wherein α is a weight, Loss₁ is the first loss, and Loss₂ is the second loss.

Aspect 4—The apparatus of any of Aspects 1-3, wherein to downscale the source image to generate the downscaled image, the one or more processors are configured to linearly downscale the source image to a resolution that is two times a final resolution of the non-linear thumbnail image.

Aspect 5—The apparatus of any of Aspects 1-4, wherein the neural network performs a non-linear transform to generate the non-linear thumbnail image.

Aspect 6—The apparatus of any of Aspects 1-5, wherein the neural network is a convolutional neural network.

Aspect 7—The apparatus of any of Aspects 1-6, wherein the original salient features include faces.

Aspect 8—The apparatus of any of Aspects 1-6, wherein the original salient features include people.

Aspect 9—The apparatus of any of Aspects 1-6, wherein the original salient features include one or more predefined objects.

Aspect 10—The apparatus of any of Aspects 1-9, wherein the one or more processors are configured to: display the non-linear thumbnail image along with other non-linear thumbnail images in a photo gallery application.

Aspect 11—A method for generating a thumbnail image, the method comprising: receiving a source image; downscaling the source image to generate a downscaled image; processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and outputting the non-linear thumbnail image.

Aspect 12—The method of Aspect 11, wherein the neural network operates according to parameters that were trained based on a loss function, and wherein the loss function is defined by a first loss relative to a saliency map ground truth and a second loss relative to a thumbnail image ground truth.

Aspect 13—The method of Aspect 12, wherein the loss function (Loss) is defined by Loss=α*Loss₁+(1−α)*Loss₂, and wherein α is a weight, Loss₁ is the first loss, and Loss₂ is the second loss.

Aspect 14—The method of any of Aspects 11-13, wherein downscaling the source image to generate the downscaled image comprises linearly downscaling the source image to a resolution that is two times a final resolution of the non-linear thumbnail image.

Aspect 15—The method of any of Aspects 11-14, wherein the neural network performs a non-linear transform to generate the non-linear thumbnail image.

Aspect 16—The method of any of Aspects 11-15, wherein the neural network is a convolutional neural network.

Aspect 17—The method of any of Aspects 11-16, wherein the original salient features include faces.

Aspect 18—The method of any of Aspects 11-16, wherein the original salient features include people.

Aspect 19—The method of any of Aspects 11-16, wherein the original salient features include one or more predefined objects.

Aspect 20—The method of any of Aspects 11-19, further comprising: displaying the non-linear thumbnail image along with other non-linear thumbnail images in a photo gallery application.

Aspect 21—A non-transitory computer-readable storage medium storing instructions that, when executed, cause one or more processors configured to generate a thumbnail image to: receive a source image; downscale the source image to generate a downscaled image; process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and output the non-linear thumbnail image.

Aspect 22—The non-transitory computer-readable storage medium of Aspect 21, wherein the neural network operates according to parameters that were trained based on a loss function, and wherein the loss function is defined by a first loss relative to a saliency map ground truth and a second loss relative to a thumbnail image ground truth.

Aspect 23—The non-transitory computer-readable storage medium of Aspect 22, wherein the loss function (Loss) is defined by Loss=α*Loss₁+(1−α)*Loss₂, and wherein α is a weight. Loss₁ is the first loss, and Loss₂ is the second loss.

Aspect 24—The non-transitory computer-readable storage medium of any of Aspects 21-23, wherein to downscale the source image to generate the downscaled image, the instructions further cause the one or more processors to linearly downscale the source image to a resolution that is two times a final resolution of the non-linear thumbnail image.

Aspect 25—The non-transitory computer-readable storage medium of any of Aspects 21-24, wherein the neural network performs a non-linear transform to generate the non-linear thumbnail image.

Aspect 26—The non-transitory computer-readable storage medium of any of Aspects 21-25, wherein the neural network is a convolutional neural network.

Aspect 27—The non-transitory computer-readable storage medium of any of Aspects 21-26, wherein the original salient features include faces.

Aspect 28—The non-transitory computer-readable storage medium of any of Aspects 21-26, wherein the original salient features include people.

Aspect 29—The non-transitory computer-readable storage medium of any of Aspects 21-26, wherein the original salient features include one or more predefined objects.

Aspect 30—The non-transitory computer-readable storage medium of any of Aspects 21-29, wherein the instructions further cause the one or more processors to: display the non-linear thumbnail image along with other non-linear thumbnail images in a photo gallery application.

Aspect 31—An apparatus configured to generate a thumbnail image, the apparatus comprising: means for receiving a source image; means for downscaling the source image to generate a downscaled image; means for processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and means for outputting the non-linear thumbnail image.

Aspect 32—The apparatus of Aspect 31, wherein the neural network operates according to parameters that were trained based on a loss function, and wherein the loss function is defined by a first loss relative to a saliency map ground truth and a second loss relative to a thumbnail image ground truth.

Aspect 33—The apparatus of Aspect 32, wherein the loss function (Loss) is defined by Loss=α*Loss₁+(1−α)*Loss₂, and wherein α is a weight, Loss₁ is the first loss, and Loss₂ is the second loss.

Aspect 34—The apparatus of any of Aspects 31-33, wherein the means for downscaling the source image to generate the downscaled image comprises means for linearly downscaling the source image to a resolution that is two times a final resolution of the non-linear thumbnail image.

Aspect 35—The apparatus of any of Aspects 31-34, wherein the neural network performs a non-linear transform to generate the non-linear thumbnail image.

Aspect 36—The apparatus of any of Aspects 31-35, wherein the neural network is a convolutional neural network.

Aspect 37—The apparatus of any of Aspects 31-36, wherein the original salient features include faces.

Aspect 38—The apparatus of any of Aspects 31-36, wherein the original salient features include people.

Aspect 39—The apparatus of any of Aspects 31-36, wherein the original salient features include one or more predefined objects.

Aspect 40—The apparatus of any of Aspects 31-39, further comprising: means for displaying the non-linear thumbnail image along with other non-linear thumbnail images in a photo gallery application.

Aspect 41—A method of training a neural network, the method comprising: processing a source image with a neural network to generate a non-linear thumbnail image, the neural network operating according to parameters, generating a thumbnail saliency map from the non-linear thumbnail image; comparing the thumbnail saliency map to a saliency map ground truth to generate a first loss value; comparing the non-linear thumbnail image to a thumbnail image ground truth to generate a second loss value; and updating the parameters based on the first loss value and the second loss value.

Aspect 42—The method of aspect 41, wherein updating the parameters based on the first loss value and the second loss value comprises updating the parameters based on a loss function of the first loss value and the second loss value, wherein the loss function (Loss) is defined by Loss=α*Loss₁+(1−α)*Loss₂, and wherein α is a weight, Loss₁ is the first loss value, and Loss₂ is the second loss value.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where discs usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Various examples have been described. These and other examples are within the scope of the following claims.

What is claimed is:

1. An apparatus configured to generate a thumbnail image, the apparatus comprising:
a memory configured to store a source image; and
one or more processors in communication with the memory, the one or more processors configured to:
receive the source image;
downscale the source image to generate a downscaled image;
process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and
output the non-linear thumbnail image.

2. The apparatus of claim 1, wherein the neural network operates according to parameters that were trained based on a loss function, and wherein the loss function is defined by a first loss relative to a saliency map ground truth and a second loss relative to a thumbnail image ground truth.

3. The apparatus of claim 2, wherein the loss function (Loss) is defined by Loss=α*Loss₁+(1−α)*Loss₂, and wherein α is a weight, Loss₁ is the first loss, and Loss₂ is the second loss.

4. The apparatus of claim 1, wherein to downscale the source image to generate the downscaled image, the one or more processors are configured to linearly downscale the source image to a resolution that is two times a final resolution of the non-linear thumbnail image.

5. The apparatus of claim 1, wherein the neural network performs a non-linear transform to generate the non-linear thumbnail image.

6. The apparatus of claim 1, wherein the neural network is a convolutional neural network.

7. The apparatus of claim 1, wherein the original salient features include faces.

8. The apparatus of claim 1, wherein the original salient features include people.

9. The apparatus of claim 1, wherein the original salient features include one or more predefined objects.

10. The apparatus of claim 1, wherein the one or more processors are configured to:
display the non-linear thumbnail image along with other non-linear thumbnail images in a photo gallery application.

11. A method for generating a thumbnail image, the method comprising:
receiving a source image;
downscaling the source image to generate a downscaled image;
processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and
outputting the non-linear thumbnail image.

12. The method of claim 11, wherein the neural network operates according to parameters that were trained based on a loss function, and wherein the loss function is defined by a first loss relative to a saliency map ground truth and a second loss relative to a thumbnail image ground truth.

13. The method of claim 12, wherein the loss function (Loss) is defined by Loss=α*Loss₁+(1−α)*Loss₂, and wherein α is a weight, Loss₁ is the first loss, and Loss₂ is the second loss.

14. The method of claim 11, wherein downscaling the source image to generate the downscaled image comprises linearly downscaling the source image to a resolution that is two times a final resolution of the non-linear thumbnail image.

15. The method of claim 11, wherein the neural network performs a non-linear transform to generate the non-linear thumbnail image.

16. The method of claim 11, wherein the neural network is a convolutional neural network.

17. The method of claim 11, wherein the original salient features include faces.

18. The method of claim 11, wherein the original salient features include people.

19. The method of claim 11, wherein the original salient features include one or more predefined objects.

20. The method of claim 11, further comprising:
displaying the non-linear thumbnail image along with other non-linear thumbnail images in a photo gallery application.

21. A non-transitory computer-readable storage medium storing instructions that, when executed, cause one or more processors configured to generate a thumbnail image to:
receive a source image;
downscale the source image to generate a downscaled image;
process the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and
output the non-linear thumbnail image.

22. An apparatus configured to generate a thumbnail image, the apparatus comprising:
means for receiving a source image;
means for downscaling the source image to generate a downscaled image;
means for processing the downscaled image with a neural network to generate a non-linear thumbnail image, wherein the neural network operates according to parameters that were trained using saliency maps, and wherein the non-linear thumbnail image includes one or more non-linearly scaled salient features relative to one or more original salient features in the source image; and
means for outputting the non-linear thumbnail image.

23. The apparatus of claim 22, wherein the neural network operates according to parameters that were trained based on a loss function, and wherein the loss function is defined by a first loss relative to a saliency map ground truth and a second loss relative to a thumbnail image ground truth.

24. The apparatus of claim 23, wherein the loss function (Loss) is defined by Loss=α*Loss₁+(1−α)*Loss₂, and wherein α is a weight, Loss₁ is the first loss, and Loss₂ is the second loss.

25. The apparatus of claim 22, wherein the means for downscaling the source image to generate the downscaled image comprises means for linearly downscaling the source image to a resolution that is two times a final resolution of the non-linear thumbnail image.

26. The apparatus of claim 22, wherein the neural network performs a non-linear transform to generate the non-linear thumbnail image.

27. The apparatus of claim 22, wherein the neural network is a convolutional neural network.

28. The apparatus of claim 22, wherein the original salient features include faces.

29. The apparatus of claim 22, wherein the original salient features include people.

30. The apparatus of claim 22, wherein the original salient features include one or more predefined objects.

31. The apparatus of claim 22, further comprising:
means for displaying the non-linear thumbnail image along with other non-linear thumbnail images in a photo gallery application.

32. A method of training a neural network, the method comprising:
processing a source image with a neural network to generate a non-linear thumbnail image, the neural network operating according to parameters;
generating a thumbnail saliency map from the non-linear thumbnail image;
comparing the thumbnail saliency map to a saliency map ground truth to generate a first loss value;
comparing the non-linear thumbnail image to a thumbnail image ground truth to generate a second loss value; and
updating the parameters based on the first loss value and the second loss value.

33. The method of claim 32, wherein updating the parameters based on the first loss value and the second loss value comprises updating the parameters based on a loss function of the first loss value and the second loss value, wherein the loss function (Loss) is defined by Loss=α*Loss₁+(1−α)*Loss₂, and wherein α is a weight, Loss₁ is the first loss value, and Loss₂ is the second loss value.
